(19) United States
(12) Patent Application Publication
(10) Pub. No.: US 2023/0339159 A1
(43) Pub. Date: Oct. 26, 2023

(54) Injection Molding Machine Management System

(71) Applicant: SEIKO EPSON CORPORATION, Tokyo (JP)

(72) Inventor: Kosuke ATSUTA, Shiojiri (JP)

(21) Appl. No.: 18/305,460

(22) Filed: Apr. 24, 2023

(30) Foreign Application Priority Data
Apr. 25, 2022 (JP) 2022-071552

(51) Int. Cl. B29C 45/17

(52) U.S. Cl. CPC B29C 45/1774; B29C 2045/7606

(57) ABSTRACT

An injection molding machine management system includes a display unit configured to display working time information as information obtained by collecting information on working data of a factory or a production line including an injection molding machine for a predetermined period. The display unit displays, as the working time information, two or more continuous pieces of information in a band shape with time length directions aligned among first information as information on a planned stop time of the injection molding machine, second information as information on a preparation time of the injection molding machine or information on an abnormal stop time of the injection molding machine, third information as time information on a performance loss of the injection molding machine, fourth information as time information on a defect loss of the injection molding machine, and fifth information as information on a value working time of the injection molding machine.

The present application is based on, and claims priority from JP Application Serial Number 2022-071552, filed Apr. 25, 2022, the disclosure of which is hereby incorporated by reference herein in its entirety.

### BACKGROUND

### 1. Technical Field

The present disclosure relates to an injection molding machine management system.

### 2. Related Art

JP-A-2004-318262 discloses a management support system that displays operation states of a plurality of machines in a band shape along a time series. In this management support system, it is possible to identify a machine that is frequently stopped due to an abnormality.

When the operation states of the injection molding machine are displayed in the band shape along the time series, it is difficult to grasp a total time of the operation states of the injection molding machine in a predetermined period. Therefore, there is a problem in that it is difficult to grasp productivity of a factory or a production line including an injection molding machine.

### SUMMARY

According to a first aspect of the present disclosure, an injection molding machine management system is provided. The injection molding machine management system includes a display unit configured to display working time information as information obtained by collecting information on working data of a factory or a production line including an injection molding machine for a predetermined period. The display unit displays, as the working time information, two or more continuous pieces of information in a band shape with time length directions aligned among first information as information on a planned stop time of the injection molding machine, second information as information on a preparation time of the injection molding machine or information on an abnormal stop time of the injection molding machine, third information as time information on a performance loss of the injection molding machine, fourth information as time information on a defect loss of the injection molding machine, and fifth information as information on a value working time of the injection molding machine.

According to a second aspect of the present disclosure, an injection molding machine management system is provided. The injection molding machine management system includes a display unit configured to display information obtained by collecting information on working data of an injection molding unit including an injection molding machine and a peripheral device of the injection molding machine for a predetermined period. The display unit displays, in a band shape with time length directions aligned, information on a planned stop time of the injection molding unit, information on a preparation time of the injection molding machine or information on an abnormal stop time of the injection molding machine, time information on a performance loss of the injection molding machine, time information on a defect loss of the injection molding machine, information on a value working time of the injection molding machine, information on a preparation time of the peripheral device or information on an abnormal stop time of the peripheral device, time information on a performance loss of the peripheral device, time information on a defect loss of the peripheral device, and information on a value working time of the peripheral device.

### BRIEF DESCRIPTION OF THE DRAWINGS

FIG. 1 is an illustrative diagram showing a schematic configuration of an injection molding machine management system according to a first embodiment.

FIG. 2 is a diagram showing an example of a management screen generated by an output unit according to the first embodiment.

FIG. 3 is a diagram showing an example of a management screen generated by an output unit according to a second embodiment.

FIG. 4 is a diagram showing an example of the management screen generated by the output unit according to the second embodiment.

FIG. 5 is a diagram showing an example of a management screen generated by an output unit according to a third embodiment.

FIG. 6 is an illustrative diagram showing a schematic configuration of an injection molding machine management system according to a fourth embodiment.

FIG. 7 is a diagram showing an example of a management screen generated by an output unit according to the fourth embodiment.

FIG. 8 is a diagram showing an example of a management screen generated by an output unit according to a fifth embodiment.

### DESCRIPTION OF EXEMPLARY EMBODIMENTS

### A. First Embodiment

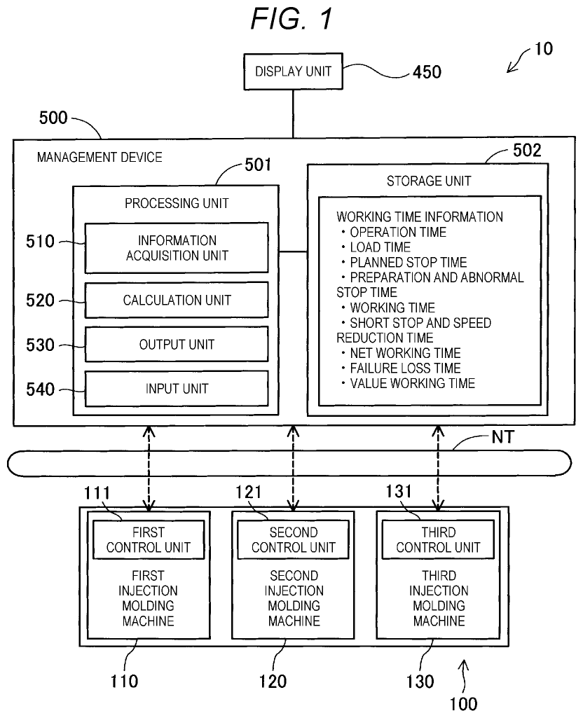

FIG. 1 is an illustrative diagram showing a schematic configuration of an injection molding machine management system 10 according to a first embodiment. The injection molding machine management system 10 includes a display unit 450 and a management device 500. The management device 500 is coupled to a plurality of injection molding machines 110, 120, and 130. The management device 500 is communicably coupled to the first injection molding machine 110, the second injection molding machine 120, and the third injection molding machine 130. The management device 500 is capable of communicating with these devices via a network NT. The network NT may be, for example, a LAN, a WAN, or an Internet. The management device 500 is also referred to as a server.

The first injection molding machine 110 includes a first control unit 111, and an injection device and a mold clamping device (both not shown). A mold having a cavity is attached to the mold clamping device. The mold may be made of metal, ceramic, or resin. The first injection molding machine 110 may be coupled to a resin material dryer that dries a resin material, a take-out machine that takes a molded product out of the first injection molding machine 110, an inspection machine that inspects the molded product, and the like. These devices constitute a production line for molded products.

The first control unit 111 is implemented by a computer including one or a plurality of processors, a storage device, and an input and output interface through which signals are input and output to and from an outside.

The first control unit 111 controls units of the first injection molding machine 110 to perform injection molding and form a molded product. More specifically, the first control unit 111 controls the mold clamping device to mold-clamp a mold, and controls the injection device to plasticize a material and inject the plasticized material into the mold, thereby forming a molded product having a shape corresponding to a shape of a cavity provided in the mold.

The first control unit 111 transmits information on working data of the first injection molding machine 110 to the management device 500. The information on working data includes a working history of the first injection molding machine 110, a preparation operation history, an abnormal stop history, a name of a produced molded item, the number of produced molded products in a predetermined period, the number of defective molded products produced in the predetermined period, and the like. The working history is, for example, an operation start time and an operation end time of the first injection molding machine 110. The preparation operation history is, for example, a time at which a preparation operation is started and a time at which the preparation operation is ended in the first injection molding machine 110. The abnormal stop history is, for example, a time at which an alarm of an abnormal stop is issued from the first injection molding machine 110 and a time at which the first injection molding machine 110 is reset from the abnormal stop. The first injection molding machine 110 abnormally stops, for example, when the take-out machine fails to take the molded product out of the mold, or when the material runs out or a safety door is forgotten to be closed.

The second injection molding machine 120 includes a second control unit 121. The third injection molding machine 130 includes a third control unit 131. The second injection molding machine 120 and the third injection molding machine 130 have the same configuration as the first injection molding machine 110. The second control unit 121 and the third control unit 131 have the same configuration as the first control unit 111. Therefore, a detailed description of the injection molding machines and the control units will be omitted. Hereinafter, when the injection molding machines 110, 120, and 130 are referred to without being distinguished, the injection molding machines 110, 120, and 130 are simply referred to as an injection molding machine 100. The number of the injection molding machines 100 coupled to the management device 500 is not limited to three, and the management device 500 may be coupled to one injection molding machine 100, two injection molding machines 100, or four or more injection molding machines 100.

The management device 500 is implemented by a computer that includes a processing unit 501 and a storage unit 502. The processing unit 501 includes one or a plurality of processors and a main storage device. The storage unit 502 is implemented by an auxiliary storage device such as a hard disk drive.

The processing unit 501 includes an information acquisition unit 510, a calculation unit 520, and an output unit 530. The information acquisition unit 510, the calculation unit 520, and the output unit 530 are implemented by the processing unit 501 executing a program stored in the storage unit 502. The processing unit 501 may include an input unit 540. The input unit 540 receives an input of information such as a working time of a user.

The information acquisition unit 510 acquires the information on working data of the injection molding machine 100 from the injection molding machine 100. The information acquisition unit 510 stores these pieces of information in the storage unit 502.

The storage unit 502 stores the information on working data of the injection molding machine 100 acquired by the information acquisition unit 510. In addition, in the storage unit 502, a working time of a day in a factory of a user and the like are stored in advance. The “user” is, for example, a worker, a work length, an administrator, or a manager.

The calculation unit 520 calculates each piece of information stored in the storage unit 502. The calculation unit 520 calculates an operation time, a load time, a planned stop time, a preparation and abnormal stop time, a working time, a short stop and speed reduction time, a net working time, a defect loss time, and a value working time in the predetermined period, and stores these times in the storage unit 502. The times described above are also collectively referred to as working time information. The working time information is information obtained by collecting the information on working data of a factory or a production line including the injection molding machine 100 for the predetermined period. In the embodiment, the predetermined period is a specified one month from January to December. Hereinafter, the “predetermined period” is also referred to as a collection period.

The output unit 530 generates a management screen for displaying the information stored in the storage unit 502 and the information calculated by the calculation unit 520. The generated management screen is output to the display unit 450 and displayed by the display unit 450.

The display unit 450 is implemented by a liquid crystal display provided in the management device 500. The management screen transmitted from the management device 500 is displayed on the display unit 450.

Hereinafter, the working time information calculated by the calculation unit 520 will be described. In the present specification, the “time” includes a year, a month, a day, a time, a minute, and a second.

In the embodiment, the operation time is a time obtained by multiplying a daily working time of a user in a factory in which the injection molding machine 100 is provided by the number of days the user works in one month. The operation time may be a time obtained by adding an overtime input to the input unit 540 by the user to the time calculated by the above-described method. The operation time may be the working time of the user within one month calculated based on a login history of an attendance system when the management device 500 is coupled to the attendance system of the user.

The load time is a time during which the injection molding machine 100 works within the operation time. When two or more injection molding machines 100 are coupled to the management device 500, the load time is an average value of working times of the injection molding machines 100. The load time is calculated based on the working history stored in the storage unit 502.

The planned stop time is a time of a difference between the operation time and the load time. The planned stop time is also referred to as first information.

The preparation and abnormal stop time is a sum of a time during which the injection molding machine 100 is stopped for the preparation operation and a time during which the injection molding machine 100 is abnormally stopped in the load time. When two or more injection molding machines 100 are coupled to the management device 500, the preparation and abnormal stop time is an average value of the times during which the injection molding machines 100 stop for the preparation operation and the times during which the injection molding machines 100 abnormally stop. The preparation and abnormal stop time is calculated based on the preparation operation history and the abnormal stop history stored in the storage unit 502. The preparation and abnormal stop time is also referred to as second information.

The working time is a time of a difference between the load time and the preparation and abnormal stop time.

The short stop and speed reduction time is a time obtained by multiplying a difference between an actual cycle time and a standard cycle time of the injection molding machine 100 by the number of molded products produced by the injection molding machine 100 within the working time. Here, the actual cycle time of the injection molding machine 100 is a value obtained by dividing the working time by the number of molded products produced by the injection molding machine 100 within the working time. The standard cycle time of the injection molding machine 100 is determined based on the actual cycle time, or a value preset by the user is stored in the storage unit 502. The standard cycle time may be, for example, an average value of the actual cycle time of one year. When two or more injection molding machines 100 are coupled to the management device 500, the short stop and speed reduction time is an average value of the short stop and speed reduction times of the injection molding machines 100. The short stop and speed reduction time is also referred to as third information.

In the present specification, a “short stop” means a fairly temporary stop of the injection molding machine 100 in which production is automatically restored and resumed even if the user does not deal with the stop. For example, in a case where the take-out machine that takes the molded product out of the mold by aspirating the molded product performs the same operation again because the molded product cannot be taken out of the mold at one time, the cycle time becomes long. The short stop and speed reduction time is a time loss that occurs when the same control is executed again or another control is executed since the device normally operates but a purpose of the operation cannot be achieved as described above. The short stop and speed reduction time is also referred to as a time related to a performance loss.

The net working time is a time of a difference between the working time and the short stop and speed reduction time.

The defect loss time is a time obtained by multiplying the net working time by a defective rate of the molded product. Here, the defective rate is a value obtained by dividing the number of defective products among the molded products produced by the injection molding machine 100 during the working time by the number of molded products produced by the injection molding machine 100 during the working time. The defect loss time is also referred to as fourth information.

The value working time is a time of a difference between the net working time and the defect loss time. The value working time is also referred to as fifth information.

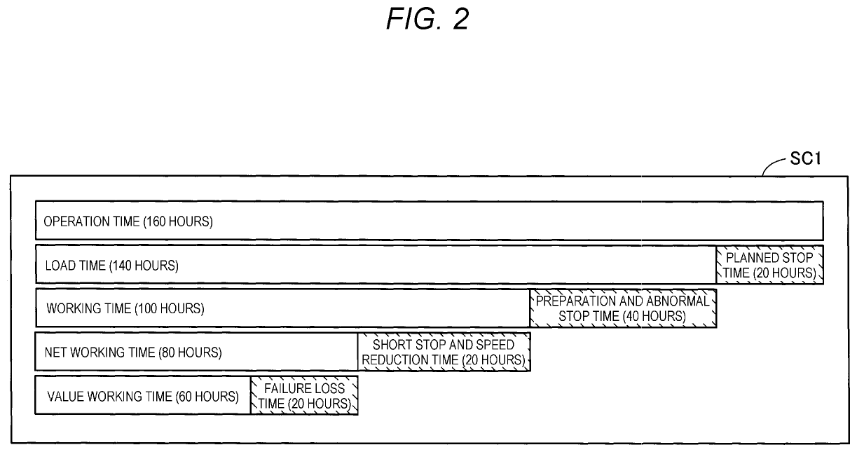

FIG. 2 is a diagram showing an example of a management screen SC1 displayed by the display unit 450 according to the embodiment. Each piece of working time information is displayed in a rectangular shape on the management screen SC1. A length of a pair of opposing sides of the rectangle is proportional to a time length of each piece of working time information. In the present specification, a direction parallel to a side having a length proportional to the time length of the working time information of the rectangle described above is referred to as a “time length direction”. The rectangles representing the working time information are displayed on the management screen SC1 such that the time length directions of all the rectangles representing the working time information are parallel to one another. In the present specification, the above-described method for displaying the working time information is referred to as “displaying the working time information in a band shape with the time length direction aligned”. In addition, the display having the band shape is also referred to as a bar display.

In the management screen SC1, the working time information is displayed in the band shape with the time length direction aligned. The operation time is displayed in the band shape at a top of the working time information with a horizontal direction as the time length direction. The load time and the planned stop time are displayed in the band shape below a bar of the operation time. The preparation and abnormal stop time and the working time are displayed in the band shape below a bar of the load time. The short stop and speed reduction time and the net working time are displayed in the band shape below a bar of the working time. The defect loss time and the value working time are displayed in the band shape below a bar of the net working time. When a plurality of bars representing the working time information are disposed side by side in contact with one another in the time length direction, the bars representing the working time information are displayed in different colors or patterns. In the bars representing the working time information, numerical values of the time lengths of the working time information are displayed. The working time information may be displayed on the management screen SC1 with a direction other than the horizontal direction as the time length direction.

Note that the management screen SC1 may display only the planned stop time, the preparation and abnormal stop time, the short stop and speed reduction time, the defect loss time, and the value working time, that is, the first information to the fifth information, without displaying the operation time, the load time, the working time, and the net working time in the working time information. Further, on the management screen SC1, instead of displaying all pieces of the first information to the fifth information, only two or more continuous pieces of information among the first information to the fifth information may be displayed in the band shape with the time length directions aligned.

According to the injection molding machine management system 10 in the first embodiment described above, the information acquisition unit 510 acquires the information on the working data of the injection molding machine 100 and stores the information in the storage unit 502, the calculation unit 520 calculates the working time information in the collection period by calculating the information stored in the storage unit 502, and the calculated working time information is displayed on the display unit 450 in the band shape with the time length direction aligned.

When the first information and the second information are displayed on the management screen SC1 in the band shape with the time length directions aligned, it is possible to visualize which of the planned stop time and the preparation and abnormal stop time of the injection molding machine 100 in the collection period is long. Further, when the second information and the third information are displayed on the management screen SC1 in the band shape with the time length directions aligned, it is possible to visualize which of the preparation and abnormal stop time and the short stop and speed reduction time of the injection molding machine 100 in the collection period is long. Further, when the third information and the fourth information are displayed on the management screen SC1 in the band shape with the time length directions aligned, it is possible to visualize which of the short stop and speed reduction time and the defect loss time of the injection molding machine 100 in the collection period is long. Further, when the fourth information and the fifth information are displayed on the management screen SC1 in the band shape with the time length directions aligned, it is possible to visualize the defective rate of the molded products produced by the injection molding machine 100 in the collection period.

If the third information, the fourth information, and the fifth information are displayed on the management screen SC1 in the band shape with the time length directions aligned, it is possible to visualize lengths of the value working time, which is a time during which the injection molding machine 100 operates while exhibiting original production efficiency, the defect loss time and the short stop and speed reduction time, which are times during which the injection molding machine 100 operates without exhibiting the original production efficiency, among the times during which the injection molding machine 100 is not stopped in the collection period.

If the first information to the fifth information are displayed on the management screen SC1 in the band shape with the time length directions aligned, it is possible to visualize a total time of each of the planned stop time, the preparation and abnormal stop time, the short stop and speed reduction time, the defect loss time, and the value working time of the injection molding machine 100 in the collection period.

Therefore, if two or more continuous pieces of information among the first information, the second information, the third information, the fourth information, and the fifth information of the injection molding machine 100 are displayed on the management screen SC1 in the band shape with the time length directions aligned, it is possible to easily grasp a total time of operation states of the injection molding machine 100 in the collection period, and thus it is possible to easily grasp productivity of the factory including the injection molding machine 100. Therefore, even a user who does not have specialized knowledge of factory management can easily recognize which of the planned stop time, the preparation and abnormal stop time, the short stop and speed reduction time, and the defect loss time is to be reduced in order to increase a ratio of the value working time to the operation time.

### B. Second Embodiment

In the first embodiment, the collection period is a specified month from January to December. On the other hand, in a second embodiment, the collection period is a period represented by a time related to an order reception of molded items. Specifically, the collection period is a period from an order reception date of production of the molded items produced in the past to a shipping delivery date. Note that the collection period may be a period from the order reception date of the production of the molded items currently being produced to a predetermined date after the order reception date. The predetermined date after the order reception date may be any date in the period from the order reception date to a current time. The predetermined date after the order reception date may be, for example, a month end date or the current date. In addition, the collection period may be a period represented by a production unit of the molded item. Specifically, the collection period may be a period from an order reception date of production in the production unit of the molded items produced in the past to the shipping delivery date. Here, the production unit of the molded item means a lot unit, a box unit, a tray unit, or the like of the molded item.

The operation time according to the second embodiment is a time during which a factory or a production line for producing an identified molded item works in the collection period. In addition, the load time according to the second embodiment is a time during which the injection molding machine 100 operates to produce the identified molded item in the collection period. The planned stop time is the difference between the operation time and the load time. Therefore, the planned stop time according to the second embodiment includes a time during which the injection molding machine 100 produces a molded item other than the identified molded item during the operation time.

In the second embodiment, the processing unit 501 of the management device 500 includes the input unit 540. The input unit 540 receives an input of information such as the order reception date of the production of the molded item and the shipping delivery date.

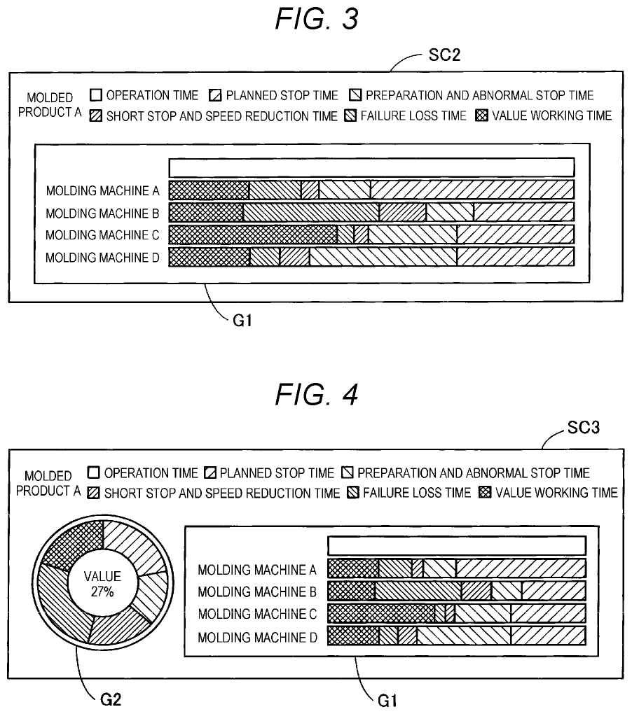

FIG. 3 is a diagram showing an example of a management screen SC2 displayed by the display unit 450 according to the second embodiment. A graph G1 is displayed on the management screen SC2. At a top of the graph G1, the operation time is displayed in the band shape. Below the bar representing the operation time, for each injection molding machine 100, the first information to the fifth information when the identified molded product is produced within the operation time are displayed in the band shape with the time length directions aligned. The first information to the fifth information of the injection molding machines 100 are displayed as a band graph such that the user can recognize a ratio of each time to the operation time.

FIG. 4 is a diagram showing an example of another management screen SC3 displayed by the display unit 450 according to the second embodiment. The graph G1 and a graph G2 are displayed on the management screen SC3. In the graph G2, an average value of each piece of the first information to the fifth information of each injection molding machine 100 when the identified molded product is produced within the operation time is displayed as a pie chart. In a center of the graph G2, the ratio of the value working time to the operation time is displayed as a numerical value.

According to the injection molding machine management system 10 in the second embodiment described above, since the first information to the fifth information of each injection molding machine 100 when the identified molded item is produced are displayed in the band shape with the time length directions aligned, it is possible to easily grasp the total time of the operation states of the injection molding machine 100 in the collection period. Therefore, for the injection molding machine 100 having a short value working time, the user can easily grasp which time among the first information to the fourth information is long. Therefore, productivity of the production line including the injection molding machine 100 can be easily grasped.

In the second embodiment, the planned stop time of the injection molding machine 100 is a sum of a time during which the injection molding machine 100 is planned to stop and a time during which the injection molding machine 100 produces a molded item other than the identified molded item. Therefore, by comparing the planned stop times of the plurality of injection molding machines 100, it is possible to easily grasp the injection molding machine 100 in which the ratio of the value working time to the operation time is small since the molded item other than the identified molded item is produced. Therefore, it is possible to easily grasp the productivity of the injection molding machine 100 when the identified molded item is produced. As a result, when the user receives an order for production of an identified molded item, the user can easily select the injection molding machine 100 having high productivity when the same molded item is produced in the past.

### C. Third Embodiment

In a third embodiment, the working time information when the injection molding machine 100 produces an identified molded item is predicted using the working time information of the injection molding machine 100 in the collection period. Specifically, during the production of the identified molded item, when a production plan of the molded item is changed due to a change of the shipping delivery date, working time information before the change of the production plan and working time information after the change of the production plan are compared. The collection period in the third embodiment is the same as the collection period in the second embodiment. The working time information in the third embodiment is calculated in the same manner as in the second embodiment.

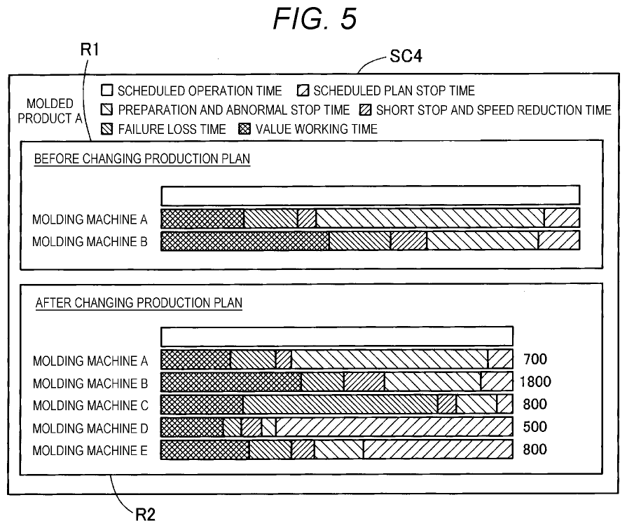

FIG. 5 is a diagram showing an example of a management screen SC4 displayed by the display unit 450 according to the third embodiment. An information display region before changing production plan R1 and an information display region after changing production plan R2 are displayed on the management screen SC4.

In the information display region before changing production plan R1, working time information before a production schedule of the molded item is changed is displayed. In the information display region before changing production plan R1, a time, from a date on which the production plan is changed to the shipping delivery date set before the production plan is changed, of the molded item currently being produced is displayed in the band shape as a scheduled operation time. Below a bar of the scheduled operation time, for each injection molding machine 100, the second information to the fifth information collected for a scheduled plan stop time and the collection period are displayed in the band shape with the time length directions aligned. The second information to the fifth information collected for the scheduled plan stop time and the collection period are displayed as a band graph such that the user can recognize a ratio of each of the second information to the fifth information to the scheduled operation time. Here, the scheduled plan stop time of the injection molding machine 100 is a sum of the planned stop time and a scheduled time for the injection molding machine 100 to operate within the scheduled operation time in order to produce a molded item other than the identified molded item.

In the information display region after changing production plan R2, working time information after the production schedule of the molded item is changed is displayed. In the information display region after changing production plan R2, a time, from the date on which the production plan is changed to the shipping delivery date after the production plan is changed, of the molded item currently being produced is displayed in a bar as the scheduled operation time. Below a bar of the scheduled operation time, for each injection molding machine 100, the second information to the fifth information collected for a scheduled plan stop time and the collection period are displayed in the band shape with the time length directions aligned. The second information to the fifth information collected for the scheduled plan stop time and the collection period are displayed as a band graph such that the user can recognize a ratio of each of the second information to the fifth information to the scheduled operation time. The number of molded products that can be produced by each injection molding machine 100 within the scheduled operation time is displayed next to the bar representing the working time information of the injection molding machine 100.

According to the injection molding machine management system 10 in the third embodiment described above, for periods before the production schedule of the molded item is changed and after the production schedule of the molded item is changed, ratios of the second information to the fifth information collected for the scheduled plan stop time and the collection period to the scheduled operation time of each injection molding machine 100 are displayed in a form of a band graph. Therefore, when the production plan of the molded item is changed, the user can easily grasp the injection molding machine 100 having a long value working time. The production efficiency of the molded product can be improved by producing the molded product using the injection molding machine 100 having a long value working time.

### D: Fourth Embodiment

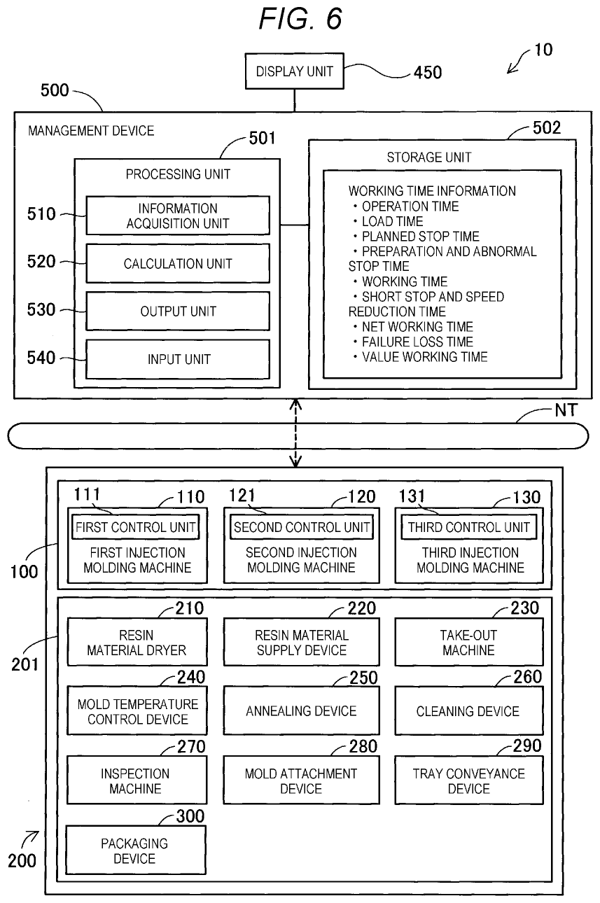

FIG. 6 is an illustrative diagram showing a schematic configuration of the injection molding machine management system 10 according to a fourth embodiment. The management device 500 is coupled to an injection molding unit 200. The injection molding unit 200 includes a molding machine 100 and peripheral devices 201. The peripheral devices 201 include at least one of a resin material dryer 210, a resin material supply device 220, a take-out machine 230, a mold temperature control device 240, an annealing device 250, a cleaning device 260, an inspection machine 270, a mold attachment device 280, a tray conveyance device 290, and a packaging device 300. The management device 500 is communicably coupled to the injection molding unit 200.

The resin material dryer 210 dries a material of the molded product formed by the injection molding machine 100. The material is, for example, a pellet-shaped resin. The resin material supply device 220 supplies the material of the molded product to a hopper of the injection molding machine 100. The take-out machine 230 takes the molded product formed by the injection molding machine 100 out of the injection molding machine 100. The mold temperature control device 240 controls a temperature of the mold attached to the mold clamping device of the injection molding machine 100. The annealing device 250 performs an annealing process on the molded product formed by the injection molding machine 100. The cleaning device 260 cleans the molded product formed by the injection molding machine 100. The inspection machine 270 inspects the molded product and determines whether the molded product is defective. The mold attachment device 280 attaches the mold to the mold clamping device of the injection molding machine 100. The tray conveyance device 290 conveys a tray that accommodates the molded products. The packaging device 300 packages the molded products.

Each of the resin material dryer 210, the resin material supply device 220, the take-out machine 230, the mold temperature control device 240, the annealing device 250, the cleaning device 260, the inspection machine 270, the mold attachment device 280, the tray conveyance device 290, and the packaging device 300 includes a control unit (not shown). These control units control the devices and transmit information on working data of the devices to the management device 500. The injection molding unit 200 may include each of the peripheral devices 201 by two or more instead of including each of the peripheral devices 201 by one.

The collection period in the fourth embodiment is the same as that in the first embodiment. The operation time, the load time, and the planned stop time in the fourth embodiment is calculated in the same manner as in the first embodiment. The planned stop time of the injection molding unit 200 and the planned stop time of the peripheral device 201 in the fourth embodiment are equal to the planned stop time of the injection molding machine 100. In the fourth embodiment, the preparation and abnormal stop time, the short stop and speed reduction time, the defect loss time, and the value working time of the peripheral device 201 are calculated in the same manner as the times of the injection molding machine 100. The collection period in the fourth embodiment may be the same as that in the second embodiment. When the collection period is the same as that in the second embodiment, the operation time, the load time, and the planned stop time in the fourth embodiment may be calculated in the same manner as in the second embodiment.

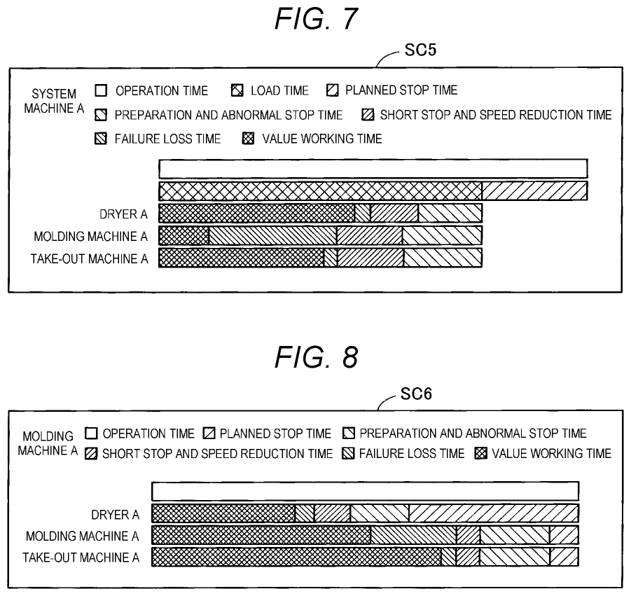

FIG. 7 is a diagram showing an example of a management screen SC5 displayed by the display unit 450 according to the fourth embodiment. On the management screen SC5, the planned stop time of the injection molding unit 200, the second information to the fifth information of the injection molding machine 100, and the second information to the fifth information of each of the peripheral devices 201 are displayed in the band shape with the time length directions aligned. The operation time is displayed in the band shape at a top of the working time information on the management screen SC5. The load time and the planned stop time are displayed in the band graph below a bar of the operation time. Below a bar of the load time, the second information to the fifth information of the injection molding machine 100 and each of the peripheral devices 201 provided in the injection molding unit 200 are displayed in the band graph. In FIG. 7, the working time information is displayed for each of the resin material dryer 210, the injection molding machine 100, and the take-out machine 230, but the working time information may be displayed for the injection molding machine 100 and all of the peripheral devices 201 provided in the injection molding unit 200.

Hereinafter, the working time information of the peripheral devices 201 will be described. An abnormal stop time of the resin material dryer 210 is, for example, a time during which the operation is stopped due to an abnormality in humidity or temperature inside the resin material dryer 210, a time during which the operation is stopped to take the material out of the resin material dryer 210 when the material cannot be used in the injection molding machine 100, or a time during which the operation is stopped due to the material running out. The short stop and speed reduction time of the resin material dryer 210 is, for example, a time during which the resin material dryer 210 operates in a heat retention state. The defective rate of the resin material dryer 210 is an amount of the material that is not used in the production of the molded product by the injection molding machine 100 with respect to an amount of the material introduced into the resin material dryer 210. The material that is not used in the injection molding machine 100 is, for example, a material spilled when the material is introduced into the resin material dryer 210 or a material removed from the resin material dryer 210 by overheating.

An abnormal stop time of the take-out machine 230 is, for example, a time during which the operation is stopped since the safety door of the take-out machine 230 is opened, a time during which the operation is stopped since the take-out machine 230 comes into contact with the injection molding machine 100 due to malfunction, or the like. The short stop and speed reduction time of the take-out machine 230 is, for example, a time during which the take-out machine 230 is stopped due to a short stop of the injection molding machine 100. The defective product generated by the take-out machine 230 is a molded product dropped since the take-out machine 230 cannot grip the molded product when the molded product is taken out of the mold of the injection molding machine 100.

Time lengths of the working time information of the injection molding machine 100 and the peripheral devices 201 do not necessarily coincide with one another. For example, although the resin material dryer 210 is stopped due to disappearance of the material in the resin material dryer 210, pellets as the material or a resin in which the material is melted may remain in a melting unit that melts the material or an injection unit that injects the material in the injection molding machine 100. In this case, even if the value working time of the resin material dryer 210 decreases, the value working time of the injection molding machine 100 or the take-out machine 230 does not decrease.

When the injection molding machine 100 is abnormally stopped, since the resin material dryer 210 continues to operate by decreasing a drying temperature, the abnormal stop time of the resin material dryer 210 does not increase, and the short stop and speed reduction time of the resin material dryer 210 increases. When the injection molding machine 100 is abnormally stopped, the molded product is not produced, and thus the take-out machine 230 is also abnormally stopped. In this case, the abnormal stop time of the injection molding machine 100 and the abnormal stop time of the take-out machine 230 are equal to each other.

When the short stop and speed reduction time of the injection molding machine 100 increases, the short stop and speed reduction time of the take-out machine 230 increases. When the short stop and speed reduction time of the injection molding machine 100 increases, a consumption amount of the material per unit time is reduced, and thus the short stop and speed reduction time of the resin material dryer 210 is increased by decreasing the drying temperature. When the drying temperature is not changed, there is a possibility that the defect loss time of the resin material dryer 210 due to overheating of the material increases.

According to the injection molding machine management system 10 in the fourth embodiment described above, the first information of the injection molding unit 200, which is the information on working data of the injection molding unit 200, and the second information to the fifth information of the injection molding machine 100 and the peripheral devices 201 in the collection period are displayed on the management screen in the band shape with the time length directions aligned. Therefore, the user can easily grasp the total time of the operation states in the collection period for each peripheral device 201 provided in the injection molding unit 200. Therefore, in order to improve the productivity of the injection molding unit 200, the user can easily consider which measure is to be taken for each peripheral device 201 provided in the injection molding unit 200.

### E. Fifth Embodiment

In a fifth embodiment, the injection molding machine 100 and the peripheral devices 201 are provided at separate places in a factory. The peripheral device 201 operates not only for an identified injection molding machine 100 but also for a plurality of injection molding machines 100. For example, the resin material dryer 210 dries not only the material used in the first injection molding machine 110 but also the material used in the second injection molding machine 120.

The collection period in the fifth embodiment is the same as that in the first embodiment. In the fifth embodiment, the working time information of the injection molding machine 100 and the peripheral devices 201 are calculated in the same manner as in the fourth embodiment except for the planned stop time of the resin material dryer 210. The planned stop time of the resin material dryer 210 is a sum of average values of the planned stop times of the plurality of resin material dryers 210 and a time during which the resin material dryer 210 dries the molded item other than the identified molded item. The collection period in the fifth embodiment may be the same as that in the second embodiment.

FIG. 8 is a diagram showing an example of a management screen SC6 displayed by the display unit 450 according to the fifth embodiment. On the management screen SC6, the first information to the fifth information of the devices of the identified injection molding machine 100 and the peripheral devices 201 are displayed in the band shape with the time length directions aligned. The operation time is displayed in the band shape at a top of the working time information on the management screen SC6. Below the bar of the operation time, the first information to the fifth information of each device of the identified injection molding machine 100 and the peripheral devices 201 are displayed in the band graph.

When the identified injection molding machine 100 is abnormally stopped, the resin material dryer 210 continues to operate by decreasing the drying temperature, or replaces the material such that the production plan of the injection molding machine 100 other than the identified injection molding machine 100 is not delayed. When the resin material dryer 210 replaces the material such that the production plan of the injection molding machine 100 other than the identified injection molding machine 100 is not delayed, the abnormal stop time of the resin material dryer 210 does not increase, and the planned stop time of the resin material dryer 210 increases.

According to the injection molding machine management system 10 in the fifth embodiment described above, the first information to the fifth information in the collection period of the identified injection molding machine 100 and the peripheral devices 201 operating also with respect to the plurality of injection molding machines 100 other than the identified injection molding machine are displayed on the management screen SC1 in the band shape with the time length directions aligned, and thus the user can easily grasp how much the identified injection molding machine 100 occupies the peripheral devices 201. Therefore, the user can easily consider which measure is to be taken for the identified injection molding machine 100 in order to increase the value working time of the peripheral device 201.

### F. Other Embodiments

(F-1) In the above embodiments, the collection period may be a period represented by any unit of year, month, day, time, minute, and second.
(F-2) In the first embodiment, the collection period may be a period represented by a time related to an order reception of a molded item, or a period represented by a production unit of the molded item. In the first embodiment, when the collection period is represented by the time related to the order reception of the molded item, the collection period may be a period from an order reception date of production of the molded item to a shipping delivery date, or the period from the order reception date of the production of the molded item to a predetermined date after the order reception date.
(F-3) In the above embodiments, when the collection period is represented by the time related to the order reception of the molded item, the order reception date of the production of the molded item and the shipping delivery date, or the order reception date of the production of the molded item and the predetermined date after the order reception date may be displayed on the management screen displayed by the display unit 450.
(F-4) In the second embodiment to the fifth embodiment, on the management screen displayed on the display unit 450, as shown in FIG. 2, information in which information on an operation time of the injection molding machine 100, information on a load time of the injection molding machine 100, information on a working time of the injection molding machine 100, and information on a net working time of the injection molding machine 100 are displayed in the band shape with time length directions aligned may be displayed together with the band graph displayed on the management screen in each embodiment, or may be displayed instead of the band graph displayed on the management screen in each embodiment.
(F-5) In the second embodiment, on the management screen displayed by the display unit 450, instead of the graph G1 or the graph G2, two or more continuous pieces of information among the first information to the fifth information of the injection molding machine 100 may be displayed in the band shape with the time length directions aligned.
(F-6) In the above embodiments, the display unit 450 may be provided in a terminal device coupled to the management device 500 via the network NT. As the terminal device, a tablet terminal, a personal computer, a smart phone, or a handy terminal can be applied.

### G. Other Aspects

The present disclosure is not limited to the above-described embodiments, and can be implemented in various aspects without departing from the spirit of the present disclosure. For example, the present disclosure can be implemented in the following aspects. In order to solve a part of or all of problems in the present disclosure, or in order to achieve a part of or all of effects in the present disclosure, technical features according to the above embodiments corresponding to technical features in the following aspects can be replaced or combined as appropriate.

In addition, when the technical characteristics are not described as essential in the present description, the technical characteristics can be deleted as appropriate.
(1) According to one aspect of the present disclosure, an injection molding machine management system is provided. The injection molding machine management system includes a display unit configured to display working time information as information obtained by collecting information on working data of a factory or a production line including an injection molding machine for a predetermined period. The display unit displays, as the working time information, two or more continuous pieces of information in a band shape with time length directions aligned among first information as information on a planned stop time of the injection molding machine, second information as information on a preparation time of the injection molding machine or information on an abnormal stop time of the injection molding machine, third information as time information on a performance loss of the injection molding machine, fourth information as time information on a defect loss of the injection molding machine, and fifth information as information on a value working time of the injection molding machine.

According to such an aspect, the user can easily grasp the total time of each of the planned stop time, the preparation and abnormal stop time, the short stop and speed reduction time, the defect loss time, and the value working time of the injection molding machine in a predetermined period in a factory or a production line including the injection molding machine. Therefore, the user can easily grasp productivity of a factory or a production line including the injection molding machine.
(2) In the above aspect, the working time information may include information on working data of the injection molding machine when the injection molding machine produces an identified molded item, and the first information may include information on a time during which the injection molding machine produces a molded item other than the identified molded item. According to such an aspect, in the predetermined period, the user can easily grasp the injection molding machine in which the ratio of the value working time to the operation time is small since the molded item other than the identified molded item is produced.
(3) According to another aspect of the present disclosure, an injection molding machine management system is provided. The injection molding machine management system includes a display unit configured to display information obtained by collecting information on working data of an injection molding unit including an injection molding machine and a peripheral device of the injection molding machine for a predetermined period. The display unit displays, in a band shape with time length directions aligned, information on a planned stop time of the injection molding unit, information on a preparation time of the injection molding machine or information on an abnormal stop time of the injection molding machine, time information on a performance loss of the injection molding machine, time information on a defect loss of the injection molding machine, information on a value working time of the injection molding machine, information on a preparation time of the peripheral device or information on an abnormal stop time of the peripheral device, time information on a performance loss of the peripheral device, time information on a defect loss of the peripheral device, and information on a value working time of the peripheral device. According to such an aspect, the user can easily grasp the first information of the injection molding unit and the second information to the fifth information of the injection molding machine and the peripheral devices in the predetermined period at the same time.
(4) In the above aspect, the peripheral device may be at least one of a resin material dryer, a resin material supply device, a take-out machine, a mold temperature control device, an annealing device, a cleaning device, an inspection machine, a mold attachment device, a tray conveyance device, and a packaging device. According to such an aspect, the user can easily grasp the first information of the injection molding unit and the second information to the fifth information of the injection molding machine and the peripheral devices described above at the same time in the predetermined period in a factory or a production line including the injection molding machine and the peripheral devices described above.
(5) In the above aspect, the predetermined period may be a period represented by any unit of year, month, day, time, minute, and second. According to such an aspect, the user can easily grasp the working time information of the injection molding machine or the peripheral devices in the unit period described above.
(6) In the above aspect, the predetermined period may be a period represented by a time related to an order reception of a molded item, or a period represented by a production unit of the molded item. According to such an aspect, the user can easily grasp the working time information of the injection molding machine or the peripheral devices in the period represented by the time related to the order reception of the molded item produced in the past or the period represented by the production unit.
(7) In the above aspect, the predetermined period may be represented by a time related to an order reception of the molded item, and the predetermined period may be (1) a period from an order reception date to a shipping delivery date, or (2) a period from an order reception date to a predetermined date after the order reception date. According to such an aspect, when the production plan of the molded item is changed, the user can easily compare the first information to the fifth information of the injection molding machine before the production plan is changed and after the production plan is changed.
(8) In the above aspect, the display unit may display, in a band shape with time length directions aligned, information on an operation time of the injection molding machine, information on a load time of the injection molding machine, information on a working time of the injection molding machine, and information on a net working time of the injection molding machine. According to such an aspect, it is possible to easily grasp not only the first information to the fifth information of the injection molding machine but also the total time of each piece of working time information of the injection molding machine in the predetermined period.

What is claimed is:

1. An injection molding machine management system comprising:
a display unit configured to display working time information as information obtained by collecting information on working data of a factory or a production line including an injection molding machine for a predetermined period, wherein
the display unit displays, as the working time information, two or more continuous pieces of information in a band shape with time length directions aligned among
first information as information on a planned stop time of the injection molding machine,
second information as information on a preparation time of the injection molding machine or information on an abnormal stop time of the injection molding machine,
third information as time information on a performance loss of the injection molding machine,
fourth information as time information on a defect loss of the injection molding machine, and
fifth information as information on a value working time of the injection molding machine.

2. The injection molding machine management system according to claim 1, wherein
the working time information includes information on working data of the injection molding machine when the injection molding machine produces an identified molded item, and
the first information includes information on a time during which the injection molding machine produces a molded item other than the identified molded item.

3. An injection molding machine management system comprising:
a display unit configured to display information obtained by collecting information on working data of an injection molding unit including an injection molding machine and a peripheral device of the injection molding machine for a predetermined period, wherein
the display unit displays, in a band shape with time length directions aligned,
information on a planned stop time of the injection molding unit,
information on a preparation time of the injection molding machine or information on an abnormal stop time of the injection molding machine,
time information on a performance loss of the injection molding machine,
time information on a defect loss of the injection molding machine,
information on a value working time of the injection molding machine,
information on a preparation time of the peripheral device or information on an abnormal stop time of the peripheral device,
time information on a performance loss of the peripheral device,
time information on a defect loss of the peripheral device, and
information on a value working time of the peripheral device.

4. The injection molding machine management system according to claim 3, wherein
the peripheral device is at least one of a resin material dryer, a resin material supply device, a take-out machine, a mold temperature control device, an annealing device, a cleaning device, an inspection machine, a mold attachment device, a tray conveyance device, and a packaging device.

5. The injection molding machine management system according to claim 1, wherein
the predetermined period is a period represented by any unit of year, month, day, time, minute, and second.

6. The injection molding machine management system according to claim 1, wherein
the predetermined period is a period represented by a time related to an order reception of a molded item, or a period represented by a production unit of the molded item.

7. The injection molding machine management system according to claim 6, wherein
the predetermined period is represented by a time related to an order reception of the molded item, and
the predetermined period is (1) a period from an order reception date to a shipping delivery date, or (2) a period from an order reception date to a predetermined date after the order reception date.

8. The injection molding machine management system according to claim 1, wherein
the display unit displays, in a band shape with time length directions aligned,
information on an operation time of the injection molding machine,
information on a load time of the injection molding machine,
information on a working time of the injection molding machine, and
information on a net working time of the injection molding machine.
